(19) United States
(12) Patent Application Publication
(10) Pub. No.: US 2025/0245819 A1
(43) Pub. Date: Jul. 31, 2025

(54) INFORMATION PROCESSING APPARATUS, METHOD OF CONTROLLING INFORMATION PROCESSING APPARATUS, AND INSPECTION SYSTEM

(71) Applicant: CANON KABUSHIKI KAISHA, Tokyo (JP)

(72) Inventor: JUNICHI SUWA, Chiba (JP)

(21) Appl. No.: 19/039,045

(22) Filed: Jan. 28, 2025

(30) Foreign Application Priority Data
Jan. 30, 2024 (JP) 2024-011552

(51) Int. Cl. G06T 7/00; G06F 3/12

(52) U.S. Cl. CPC G06T 7/001; G06F 3/1208; G06F 3/1256; G06T 2207/30144

(57) ABSTRACT

An information processing apparatus configured to perform setting to inspect a printed sheet includes: at least one memory that stores instructions; and at least one processor that executes the instructions to: set an inspection region for each inspection level indicating accuracy of the inspection based on a first user instruction for a reference image, which is a reference for the inspection; and extract an object existing in the reference image, in which in a case where a plurality of inspection regions which have the different inspection levels are set for the extracted object based on the first user instruction, one inspection region is determined from the plurality of the inspection regions based on a proportion of each of the plurality of the inspection regions included in the object, and the inspection level corresponding to the determined one inspection region is set as the inspection level for the object.

### BACKGROUND OF THE INVENTION

### Field of the Invention

The present disclosure relates to an information processing apparatus, a method of controlling the information processing apparatus, and an inspection system.

### Description of the Related Art

In the field of commercial printing, an inspection system has become popular that performs inspection of a printed product on which a design and a character are printed by detecting a printing defect such as dirt and positional shift of an image on the printed product by a reading sensor installed in a conveyance route. In the inspection by an operator, it takes time and effort, and the inspection accuracy depends on the skill of the operator; for this reason, the inspection system is used to improve the quality and reduce the work time. Japanese Patent Laid-Open No. 2021-187071 (hereinafter, referred to as “Document 1”) discloses a technique of easily and simply setting an inspection region reflecting the intent of the operator by surrounding the inspection region with a rectangular and the like on a reference image, which is a reference for the inspection in a case of the inspection of the printed product, in order to reduce the work time of the operator in the above-described inspection system. Additionally, in the technique according to Document 1, in a case where the inspection region set by a user overlaps with a blank region, an inspection region obtained by excluding the blank region from the inspection region set by the user is automatically set again, and thus the usability is enhanced.

### SUMMARY OF THE INVENTION

An information processing apparatus according to the present disclosure is an information processing apparatus configured to perform setting to inspect a printed sheet includes: at least one memory that stores instructions; and at least one processor that executes the instructions to: set an inspection region for each inspection level indicating accuracy of the inspection based on a first user instruction for a reference image, which is a reference for the inspection; and extract an object existing in the reference image, in which in a case where a plurality of inspection regions which have the different inspection levels are set for the extracted object based on the first user instruction, one inspection region is determined from the plurality of the inspection regions based on a proportion of each of the plurality of the inspection regions included in the object, and the inspection level corresponding to the determined one inspection region is set as the inspection level for the object.

Further features of the present disclosure will become apparent from the following description of exemplary embodiments with reference to the attached drawings.

### BRIEF DESCRIPTION OF THE DRAWINGS

FIG. 1 is a diagram illustrating a system configuration of an inspection system according to the present disclosure;

FIG. 2 is a hardware configuration diagram of the inspection system according to a first embodiment;

FIG. 3 is a functional block diagram of software of a second information processing apparatus according to the first embodiment;

FIG. 4 is a diagram illustrating an example of a UI screen of the second information processing apparatus;

FIG. 5 is a diagram illustrating an example of the UI screen indicating setting of an inspection region;

FIG. 6 is a diagram illustrating an example of each object as an inspection target;

FIG. 7A is a diagram illustrating an example of inspection region setting of an object in which the inspection regions overlap with each other;

FIG. 7B is a diagram illustrating an example of inspection region setting of an object in which the inspection regions overlap with each other;

FIG. 8 is a flowchart illustrating processing of setting an inspection level; and

FIG. 9 is a flowchart illustrating processing of setting the inspection level.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

### First Embodiment

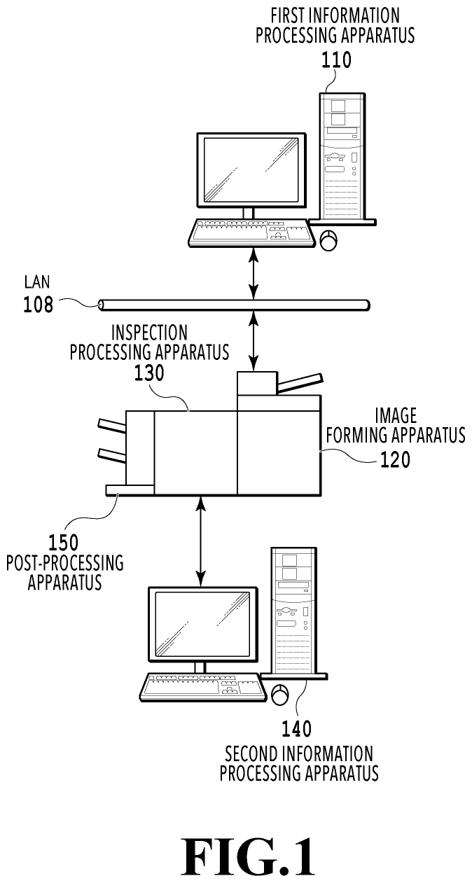

FIG. 1 is a diagram illustrating a system configuration of an inspection system according to the present embodiment. In the present inspection system, a configuration in which a first information processing apparatus 110 as a host computer and an image forming apparatus (printing apparatus) 120 are connected to each other through a LAN 108 is adopted. The first information processing apparatus 110 is assumed to be a personal computer (PC); however, it is not limited thereto. The first information processing apparatus 110 may be a tablet terminal, a smartphone, or a personal digital assistant (PDA) terminal. The image forming apparatus 120 performs printing processing by receiving a printing job and forming an image on a sheet. The printed sheet is conveyed to an inspection processing apparatus 130, and a sheet surface on which the printing is performed is read. The read image information is transferred to a second information processing apparatus 140, and the inspection is performed. The printed sheet on which the reading ends is conveyed to a post-processing apparatus 150.

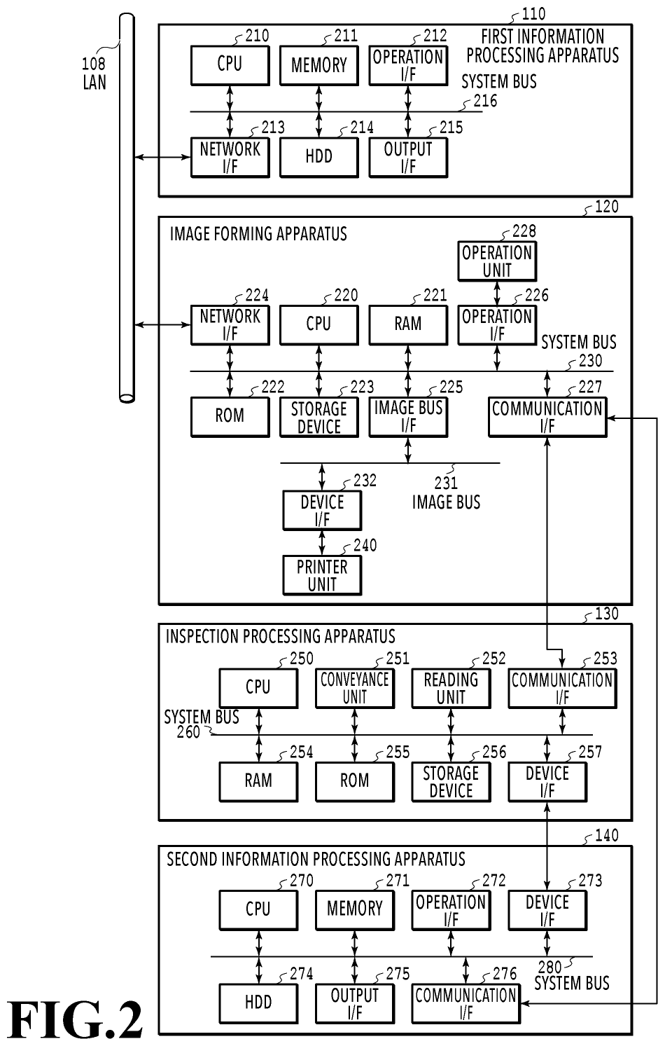

FIG. 2 is a hardware configuration diagram of the first information processing apparatus 110, the image forming apparatus 120, the inspection processing apparatus 130, and the second information processing apparatus 140 according to the present embodiment. The first information processing apparatus 110 includes a CPU 210 that controls overall the first information processing apparatus 110, a memory 211, and a hard disk drive (HDD) 214. The CPU 210 performs various controls such as printing control by reading out a control program saved in the memory 211 or the HDD 214 and executing the program. In the present embodiment, a storage device is assumed to be the HDD 214; however, it is not limited thereto. The storage device may be a non-volatile memory such as an SSD and a flash memory.

An operation unit that operates the first information processing apparatus 110 is connected to the first information processing apparatus 110 through an operation unit I/F 212. For example, the operation unit functions as a reception unit that includes a liquid crystal display unit having a touch panel function, various hardware keys or the like and is connected to the first information processing apparatus 110 to receive a user instruction. The first information processing apparatus 110 is connected to the LAN 108 by way of a network I/F 213 and transfers information required for printing to the image forming apparatus 120. Additionally, the first information processing apparatus 110 includes an output I/F 215 to output information in the first information processing apparatus 110. The data outputted from the first information processing apparatus 110 by way of the output I/F 215 is displayed on an output device such as a display. The units described above are connected to each other on a system bus 216.

The image forming apparatus 120 includes a CPU 220, a RAM 221, a ROM 222, a storage device 223, an operation unit 228, and a printer unit 240. The CPU 220 is a central processing unit that controls overall the image forming apparatus 120. The RAM 221 is a system working memory that allows the CPU 220 to operate. Additionally, the RAM 221 is also a memory that temporarily stores a PDL transmitted to the image forming apparatus 120, intermediate data generated in the image forming apparatus 120 for printing processing, a working region in a case of rendering processing, and inputted image data. In this case, the PDL is Page Description Language. The ROM 222 is a boot ROM and stores a boot program of a system. The storage device 223 is a hard disk drive (HDD) and stores system software for various types of processing and the PDL transmitted to the image forming apparatus 120. The storage device 223 is not limited to the above-described HDD and may be a non-volatile memory such as an SSD and a flash memory.

An operation unit I/F 226 is an interface unit for the operation unit 228 including a display screen that can display various menus, printing data information, or the like and outputs operation screen data to the operation unit 228. Additionally, the information inputted by the operator from the operation unit 228 is transmitted to the CPU 220. A network I/F 224 is connected to the LAN 108 and inputs and outputs information to and from an external apparatus. A communication I/F 227 is connected to the inspection processing apparatus 130 and performs the inspection processing of the printed sheet on which the image forming apparatus 120 performs the printing. An image bus I/F 225 is an interface that connects a system bus 230 to an image bus 231 that transfers image data at high speed and is a bus bridge that converts a data structure. The above-described units are connected to each other by way of the system bus 230. Moreover, a device I/F 232 is connected on the image bus 231. The printer unit 240 is connected to the device I/F 232 and outputs the image data transferred from the image bus 231 to the sheet.

The inspection processing apparatus 130 includes a CPU 250, a conveyance unit 251, a reading unit 252, a RAM 254, a ROM 255, and a storage device 256. The CPU 250 is a central processing unit that controls overall the inspection processing apparatus 130. The RAM 254 is a system working memory that allows the CPU 250 to operate. The ROM 255 is a boot ROM and stores a boot program of a system. The storage device 256 stores software and various data for various types of processing. In the present embodiment, as the storage device 256, an HDD, an SSD, a flash memory, or the like is used.

The inspection processing apparatus 130 conveys the printed sheet conveyed from the image forming apparatus 120 to the conveyance unit 251, reads a print side by the reading unit 252, and obtains a scanned image. The scanned image is saved in the storage device 256, and the saved scanned image is transmitted to the second information processing apparatus 140 by way of a device I/F 257. Additionally, the inspection processing apparatus 130 communicates with the image forming apparatus 120 by way of a communication I/F 253, and transmission and reception of various pieces of information and data between the inspection processing apparatus 130 and the image forming apparatus 120 are performed. The above-described units are connected to each other on a system bus 260.

The second information processing apparatus 140 includes a CPU 270, a memory 271, and an HDD 274. The CPU 270 is a central processing unit that controls overall the second information processing apparatus 140 and reads out a control program saved in the memory 271 and the HDD 274 to perform various controls such as image comparison control in the inspection. In the present embodiment, the storage device is assumed to be the HDD 274; however, it is not limited thereto. The storage device may be a non-volatile memory such as an SSD and a flash memory.

The second information processing apparatus 140 receives the image information transmitted from the inspection processing apparatus 130 by way of a device I/F 273, compares the scanned image to the reference image set in advance, and performs the inspection to detect an image defect such as dirt and a line on the scanned image. In addition, the second information processing apparatus 140 transmits and receives the information such as the PDL to and from the image forming apparatus 120 by way of a communication I/F 276. An operation unit I/F 272 is an interface that inputs setting in various menus in the inspection. An output I/F 275 is an interface that outputs a result such as an inspection result, setting information, and an area ratio to an output device such as a display panel. The above-described units are connected to each other on a system bus 280. In the present embodiment, the second information processing apparatus 140 is an information processing apparatus as a separated body; however, it is not limited thereto. The second information processing apparatus 140 may be included in the first information processing apparatus 110, the image forming apparatus 120, or the inspection processing apparatus 130.

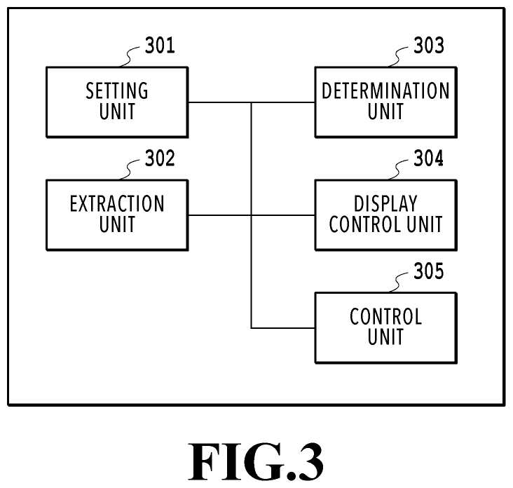

FIG. 3 is a functional block diagram of software of the second information processing apparatus 140 according to a first embodiment. The units forming the software of the second information processing apparatus 140 are stored in the HDD 274, transferred to the memory 271, and executed by the CPU 270. The second information processing apparatus 140 includes a setting unit 301, an extraction unit 302, a determination unit 303, a display control unit 304, and a control unit 305.

The setting unit 301 arranges plural inspection regions of different inspection levels on the reference image. Additionally, in a case where an object includes the plural inspection regions, the setting unit 301 calculates a proportion of each of the inspection regions included in the object and sets the inspection levels to the object based on the calculation results. In this case, the proportion of the inspection region included in the object is also called the area ratio (an area proportion). The extraction unit 302 extracts the object existing in the reference image. The determination unit 303 determines whether the object includes the plural inspection regions. The display control unit 304 performs display control of the display panel. The control unit 305 performs various controls.

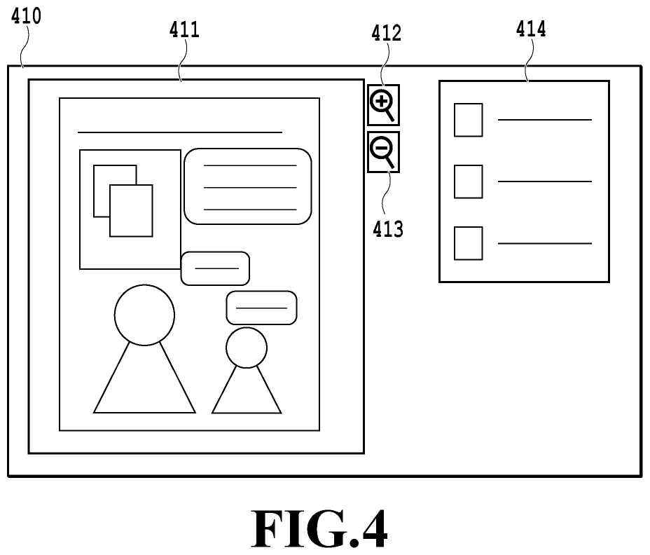

FIG. 4 is an example of a UI screen displayed on the display panel of the second information processing apparatus 140. In the example illustrated in FIG. 4, a range displayed on the display panel is a UI display region 410. In the UI display region 410, the reference image used in a case of performing the inspection is displayed in a display region 411. In a case of zooming in on the displayed reference image, a zoom-in input button 412 is pressed to zoom in, and in a case of zooming out, a zoom-out input button 413 is pressed to zoom out. The user selects the inspection region arbitrarily from the reference image displayed in the display region 411 and sets the inspection region.

In an inspection level setting region 414, the inspection level is set to each of the plural inspection regions. The inspection level indicates accuracy of the detection of the printing defect such as dirt, a line, or dust in the designated inspection region. For example, as the inspection level is higher, smaller dirt is detected to detect the printing defect. The setting of the inspection level is described later.

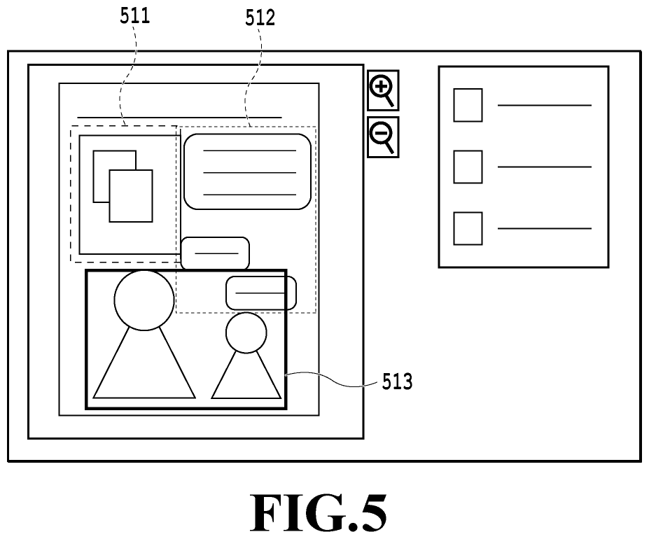

FIG. 5 is an example of the UI screen indicating the setting of the inspection region. In the example illustrated in FIG. 5, each region that is desired to be inspected based on the user instruction is surrounded by a frame, and the inspection level is set. For example, in a first inspection region 511, the “inspection level” is set to “low”. In a second inspection region 512, the “inspection level” is set to “medium”. In a third inspection region 513, the “inspection level” is set to “high”.

In the inspection region in which the different inspection levels are set to be overlapping with each other, the displaying is performed in the form that allows for the identification of the difference between the inspection levels as illustrated in FIG. 5. For example, in the example illustrated in FIG. 5, the form of displaying the inspection frame is indicated by a bold line, a broken line, and the like; however, it is not limited thereto. For example, the inspection frames may be displayed with different colors. Alternatively, the correspondence between the display of each inspection frame and the inspection level may be identified with reference to the inspection level setting region 414. In the example illustrated in FIG. 5, the regions are set to be partially overlapping with each other in the second inspection region 512 and the third inspection region 513.

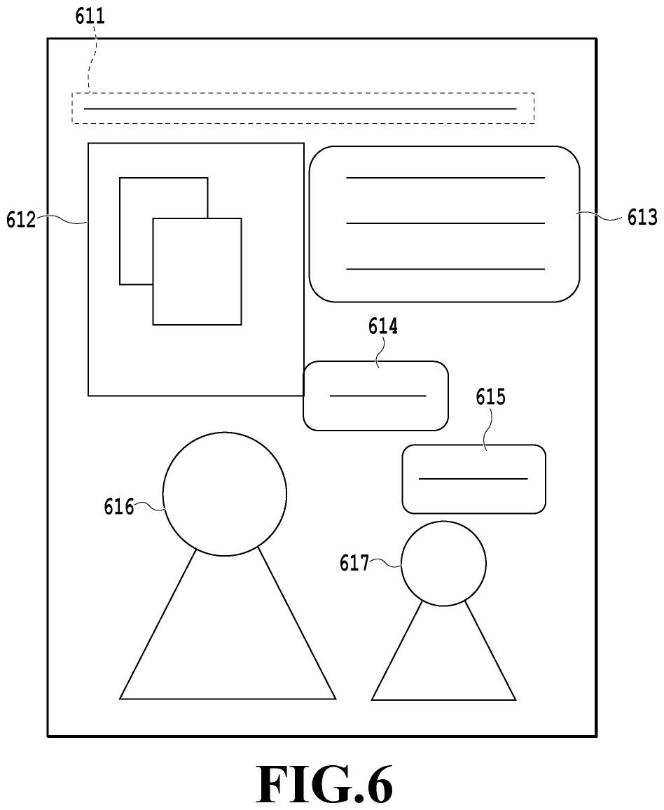

FIG. 6 is a diagram illustrating an example of each object as an inspection target. The object in the present embodiment is a person image, a character string, and the like in a design. The object as the inspection target illustrated in FIG. 6 is divided into seven objects, which are a first object 611 to a seventh object 617. A method of detecting each object is described later.

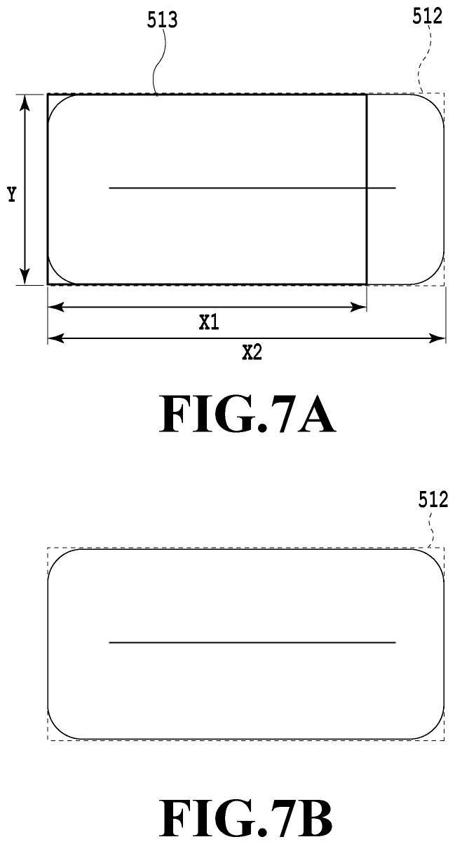

FIGS. 7A and 7B are diagrams illustrating an example of the inspection region setting of the object in which the inspection regions overlap with each other. In the inspection regions illustrated in FIGS. 5 and 6, the fifth object 615 is a region in which the third inspection region 513 of a high inspection level overlaps with the second inspection region 512 of a medium inspection level. That is, the different inspection levels are set for one object (see FIG. 7A).

The area ratio of each inspection region with respect to the fifth object 615 illustrated in FIG. 7A is calculated. The third inspection region 513 (inspection level: high) is 80%, and the second inspection region 512 (inspection level: medium) is 100%. Additionally, a method of calculating the area ratio of each inspection region with respect to the object is as follows by using widths (X1, X2) and a height Y illustrated in FIG. 7A. The area ratio of the third inspection region 513 (inspection level: high) is calculated by (X1×Y)/(X2×Y). The area ratio of the second inspection region 512 (inspection level: medium) is calculated by (X2×Y)/(X2×Y).

In a case where the inspection regions of the different inspection levels are included in one object, in the present embodiment, the area ratio with respect to the object is calculated for each inspection region, and the calculated area ratios are compared to each other. In addition, the inspection level designated for the inspection region having the largest area ratio is set for the object. That is, one inspection level is set for one object. In a case of FIG. 7A, the “inspection level: middle” that is designated for the second inspection region 512 of the area ratio, which is larger than the area ratio of the third inspection region 513, is set for the object (see FIG. 7B).

Additionally, as another example in which the inspection regions overlap with each other in one object, here is considered a case where the area ratio of the inspection region of the high inspection level is 70%, and the area ratio of the inspection region of the medium inspection level is 50%. In the above-described case, the inspection level of the object is set according to the high inspection level of the inspection region with the area ratio larger than that of the inspection region of the medium inspection level. In addition, as yet another example, as for the sixth object 616 and the seventh object 617 of the person image illustrated in FIG. 6, a boundary between the person image and a background is detected by a later-described method, and the inspection level is set according to the shape of the object of the person image.

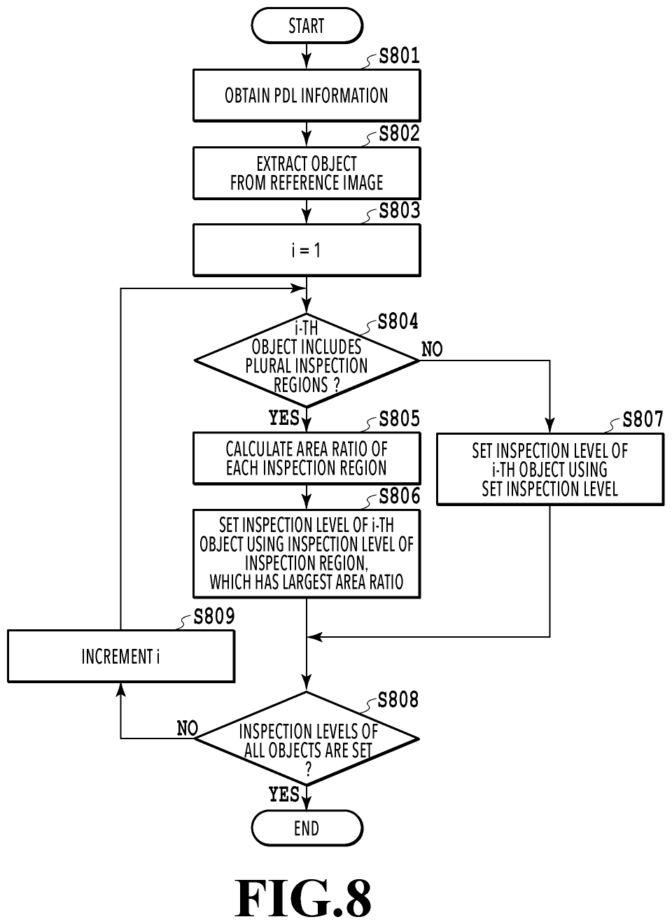

FIG. 8 is a flowchart illustrating processing of setting the inspection level. In the present embodiment, the CPU 270 of the second information processing apparatus 140 determines whether the object includes the plural inspection regions of the different inspection levels and sets one proper inspection level for the object including the plural inspection regions of the different inspection levels. The above-described processing is implemented with the CPU 270 of the second information processing apparatus 140 executing a predetermined program corresponding to the flowchart in FIG. 8. In a case where the setting unit 301 arranges the inspection regions of the different inspection levels in the reference image by a user operation, processing of the flowchart illustrated in FIG. 8 is started.

In S801, the control unit 305 of the second information processing apparatus 140 obtains the PDL information from the image forming apparatus 120, and the processing proceeds to S802. In S802, the extraction unit 302 extracts the object from the reference image, and the processing proceeds to S803. As an example of the extraction method, a character region is extracted by using optical character recognition (OCR), and as for the object other than the character, an image object and a graphic object other than the character are extracted by using edge detection. Hereinafter, the character region is also referred to as a character object. In addition, the extraction unit 302 also refers to the PDL information obtained in S801 and extracts the object that is not extracted by the OCR processing and the like. The extraction results of these objects are the results illustrated in FIG. 6, for example.

In S803, a variable i is initialized to “1”, and the processing proceeds to S804. In S804, the determination unit 303 determines whether the i-th object includes the plural inspection regions. In a case where the i-th object includes the plural inspection regions, the processing proceeds to S805. In a case where the i-th object does not include the plural inspection regions, the processing proceeds to S807.

In S805, the setting unit 301 calculates the area ratio indicating the proportion of each inspection region included in the i-th object. Once the area ratio is calculated, the processing proceeds to S806. In S806, the setting unit 301 confirms the area ratio calculated with respect to the i-th object and determines the inspection region of the largest area ratio. Then, the setting unit 301 sets the inspection level of the i-th object to the inspection level designated for the inspection region having the largest area ratio. Once the setting of the inspection level is completed, the processing proceeds to S808.

In S807, since the i-th object does not include the plural inspection regions, the setting unit 301 sets the inspection level of the i-th object by using the inspection level of the designated inspection region. Once the setting of the inspection level is completed, the processing proceeds to S808. In S808, the control unit 305 determines whether the inspection levels of all the objects are set. In a case where the inspection levels of all the objects are not set, the processing proceeds to S809. In a case where the inspection levels of all the objects are set, the processing flow of the flowchart illustrated in FIG. 8 ends. In S809, the variable i is incremented, and the processing returns to S804. In the present embodiment, a case where two inspection regions overlap with each other in one object is described; however, it is not limited thereto. The present disclosure is also applicable to a case where three or more inspection regions are included in one object.

As described above, in a case where the object includes the plural inspection regions in the reference image, the proportion of each of the inspection regions included in the object is calculated, and the inspection level is set for the object based on the calculation results. Thus, it is possible to properly set the inspection region in the reference image. Accordingly, it is possible to perform the inspection at the inspection level intended by the user.

### Second Embodiment

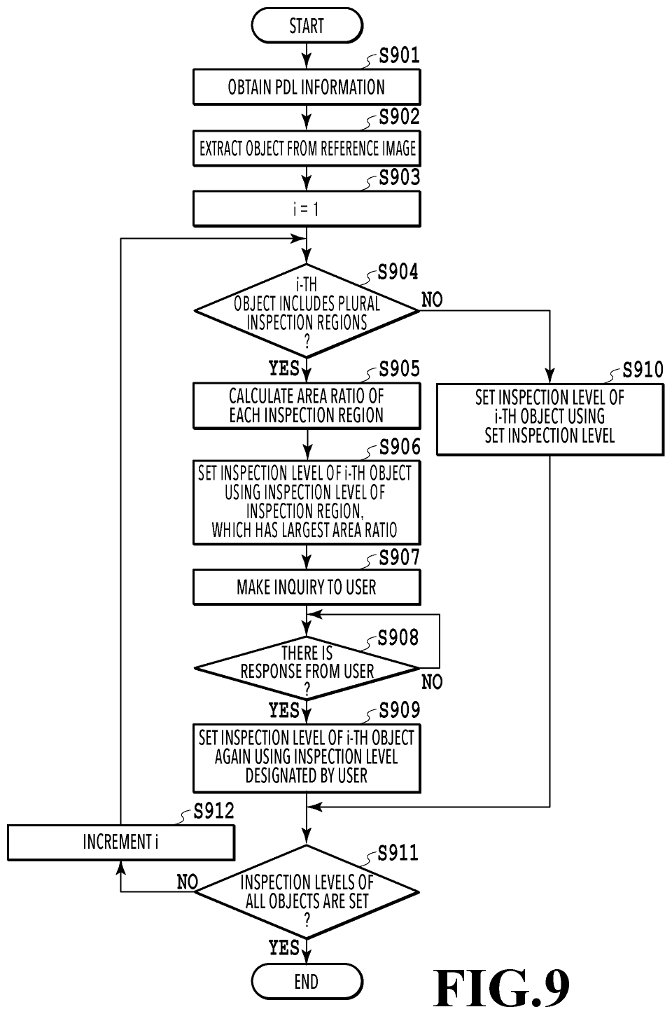

FIG. 9 is a flowchart illustrating processing of setting the inspection level. In the first embodiment, the second information processing apparatus 140 determines whether the object includes the plural inspection regions, calculates the proportion of each of the inspection regions included in the object including the plural inspection regions, and sets the proper inspection level for the object. In the present embodiment, a processing flow of processing of setting the inspection level for the object after an inquiry to the user is made is described. The processing is implemented with the CPU 270 of the second information processing apparatus 140 executing a predetermined program corresponding to the flowchart in FIG. 9. Once the setting unit 301 arranges the inspection regions of the different inspection levels in the reference image by the user operation, the processing of the flowchart illustrated in FIG. 9 is started.

In S901, the control unit 305 of the second information processing apparatus 140 obtains the PDL information from the image forming apparatus 120, and the processing proceeds to S902. In S902, the extraction unit 302 extracts the object from the reference image, and the processing proceeds to S903. As an example of the extraction method, the character object is extracted by using the OCR processing, and as for the object other than the character, the image object and the graphic object other than the character are extracted by using the edge detection. In addition, the extraction unit 302 extracts the object that is not extracted by the OCR processing and the like with reference to the PDL information obtained in S901.

In S903, the variable i is initialized to “1”, and the processing proceeds to S904. In S904, the determination unit 303 determines whether the i-th object includes the plural inspection regions. In a case where the i-th object includes the plural inspection regions, the processing proceeds to S905. In a case where the i-th object does not include the plural inspection regions, the processing proceeds to S910.

In S905, the setting unit 301 calculates the area ratio indicating the proportion of each of the inspection regions included in the i-th object. Once the area ratio is calculated, the processing proceeds to S906. Once the area ratio of each inspection region is calculated, the display control unit 304 may display the area ratio with respect to the i-th object for each inspection region on the display panel.

In S906, the setting unit 301 confirms the area ratio calculated with respect to the i-th object and determines the inspection region of the largest area ratio. Then, the setting unit 301 sets the inspection level of the i-th object to the inspection level designated for the inspection region having the largest area ratio. Once the setting of the inspection level is completed, the processing proceeds to S907.

In S907, the setting unit 301 inquires of the user which inspection level to set. Once the inquiry to the user is executed, the processing proceeds to S908. In S908, the control unit 305 confirms whether there is a response from the user. In a case where there is the response from the user, the processing proceeds to S909. In a case where there is no response from the user, the processing executes S908 and waits for the response from the user.

In S909, the setting unit 301 sets again the inspection level based on a user instruction in the response from the user for the object, and the processing proceeds to S911. In a case where the user responds to the inquiry, the user instruction may be performed based on the area ratio of each inspection region displayed on the above-described display panel.

In S910, since the i-th object does not include the plural inspection regions, the setting unit 301 sets the inspection level of the i-th object by using the inspection level of the designated inspection region. Once the setting of the inspection level is completed, the processing proceeds to S911. In S911, the control unit 305 determines whether the inspection levels of all the objects are set. In a case where the inspection levels of all the objects are not set, the processing proceeds to S912. In a case where the inspection levels of all the objects are set, the processing flow of the flowchart illustrated in FIG. 9 ends. In S912, the variable i is incremented, and the processing returns to S904. In the present embodiment, a case where two inspection regions overlap with each other in one object is described; however, it is not limited thereto. The present disclosure is also applicable to a case where three or more inspection regions are included in one object.

As described above, in a case where the object includes the plural inspection regions, the proportion of the inspection regions each included in the object is calculated, and the inspection level is set for the object based on the calculation results and the user instruction. Thus, it is possible to properly set the inspection region in the reference image. Accordingly, it is possible to perform the inspection at the inspection level intended by the user.

### Modification of Second Embodiment

In the above-described second embodiment, in a case where the object includes the plural inspection regions, the inquiry to the user is constantly made; however, it is not limited thereto. The inquiry to the user may be made in a case where the proportion of the inspection regions each included in the target object satisfies a predetermined condition. For example, in a case where there are plural inspection regions of the proportion of the inspection regions included in the target object that is equal to or larger than a first threshold, the inquiry to the user may be made, and the inspection level based on the user instruction in the response from the user may be set again to the object. As a specific example of the first threshold, 40% or 50% is designated, for example. Otherwise, the inspection level designated for the inspection region having the largest area ratio in the target object is set as the inspection level of the object.

Alternatively, in a case where there is the inspection region that has a value of the proportion in the target object that is different by a second threshold or smaller from the largest value of the proportion of the inspection region included in the target object, the inquiry to the user may be made, and the inspection level based on the user instruction in the response from the user may be set again to the object. As a specific example of the second threshold, 15% or 25% is designated, for example. Otherwise, the inspection level designated for the inspection region having the largest area ratio in the target object is set as the inspection level of the object.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-011552, filed Jan. 30, 2024, which is hereby incorporated by reference wherein in its entirety.

What is claimed is:

1. An information processing apparatus configured to perform setting to inspect a printed sheet, comprising:
at least one memory that stores instructions; and
at least one processor that executes the instructions to:
set an inspection region for each inspection level indicating accuracy of the inspection based on a first user instruction for a reference image, which is a reference for the inspection; and
extract an object existing in the reference image, wherein
in a case where a plurality of inspection regions which have the different inspection levels are set for the extracted object based on the first user instruction,
one inspection region is determined from the plurality of the inspection regions based on a proportion of each of the plurality of the inspection regions included in the object, and
the inspection level corresponding to the determined one inspection region is set as the inspection level for the object.

2. The information processing apparatus according to claim 1, wherein
the at least one processor executes the instructions further to:
determine the inspection level designated for an inspection region having the largest proportion included in the object as the inspection level corresponding to the one inspection region.

3. The information processing apparatus according to claim 1, wherein
the at least one processor executes the instructions further to:
make an inquiry to a user is made after the inspection level corresponding to the one inspection region is set as the inspection level for the object; and
set the inspection level for the object again based on a second user instruction in response to the inquiry to the user.

4. The information processing apparatus according to claim 1, wherein
the at least one processor executes the instructions further to:
make an inquiry to a user after the inspection level corresponding to the one inspection region is set as the inspection level for the object in a case where a predetermined condition is satisfied; and
set the inspection level for the object again based on a second user instruction in response to the inquiry to the user.

5. The information processing apparatus according to claim 4, wherein
the at least one processor executes the instructions further to:
determine the inspection level designated for an inspection region having the largest proportion included in the object as the inspection level corresponding to the one inspection region in a case where the predetermined condition is not satisfied.

6. The information processing apparatus according to claim 4, wherein
the predetermined condition is that there are a plurality of the inspection regions having the proportions included in the object, which are equal to or larger than a first threshold.

7. The information processing apparatus according to claim 6, wherein
the first threshold is 50%.

8. The information processing apparatus according to claim 4, wherein
the predetermined condition is that there is the inspection region having the proportion included in the object in which a difference from the largest proportion included in the object is equal to or smaller than a second threshold.

9. The information processing apparatus according to claim 8, wherein
the second threshold is 25%.

10. The information processing apparatus according to claim 1, wherein
the at least one processor executes the instructions further to:
control a display unit; and
display the proportion of each of the plurality of the inspection regions included in the object on the display unit.

11. A method of controlling an information processing apparatus configured to perform setting to inspect a printed sheet; comprising:
setting an inspection region for each inspection level indicating accuracy of the inspection based on a first user instruction for a reference image, which is a reference for the inspection; and
extracting an object existing in the reference image; and
in a case where a plurality of inspection regions having the different inspection levels are set for the extracted object in the extracting step,
determining one inspection region from the plurality of the inspection regions based on a proportion of each of the plurality of the inspection regions included in the object, and
setting the inspection level corresponding to the determined one inspection region as the inspection level for the object.

12. An inspection system, comprising:
a printing apparatus configured to perform printing on a sheet based on image data designated by a printing job;
an information processing apparatus configured to perform setting to inspect a printed sheet; and
an inspection apparatus configured to perform the inspection on the printed sheet based on the setting set by the information processing apparatus, wherein
the information processing apparatus comprises:
at least one memory that stores instructions; and
at least one processor that executes the instructions to:
set an inspection region for each inspection level indicating accuracy of the inspection based on a first user instruction for a reference image, which is a reference for the inspection; and
extract an object existing in the reference image, wherein
in a case where a plurality of inspection regions which have the different inspection levels are set for the extracted object based on the first user instruction,
one inspection region is determined from the plurality of the inspection regions based on a proportion of each of the plurality of the inspection regions included in the object, and
the inspection level corresponding to the determined one inspection region is set as the inspection level for the object.

13. The inspection system according to claim 12, wherein
the at least one processor of the information processing apparatus executes the instructions further to:
determine the inspection level designated for an inspection region having the largest proportion included in the object as the inspection level corresponding to the one inspection region.

14. The inspection system according to claim 12, wherein
the at least one processor of the information processing apparatus executes the instructions further to:
make an inquiry to a user is made after the inspection level corresponding to the one inspection region is set as the inspection level for the object; and
set the inspection level for the object again based on a second user instruction in response to the inquiry to the user.

15. The inspection system according to claim 12, wherein
the at least one processor of the information processing apparatus executes the instructions further to:
make an inquiry to a user after the inspection level corresponding to the one inspection region is set as the inspection level for the object in a case where a predetermined condition is satisfied; and
set the inspection level for the object again based on a second user instruction in response to the inquiry to the user.

16. The inspection system according to claim 15, wherein
the at least one processor of the information processing apparatus executes the instructions further to:
determine the inspection level designated for an inspection region having the largest proportion included in the object as the inspection level corresponding to the one inspection region in a case where the predetermined condition is not satisfied.

17. The inspection system according to claim 12, wherein
the at least one processor of the information processing apparatus executes the instructions further to:
control a display unit; and
display the proportion of each of the plurality of the inspection regions included in the object on the display unit.
